(19) United States
(12) Patent Application Publication
(10) Pub. No.: US 2007/0036067 A1
(43) Pub. Date: Feb. 15, 2007

(54) METHOD AND APPARATUS FOR SENDING DOWNLINK CONTROL INFORMATION IN AN ORTHOGONAL FREQUENCY DIVISION MULTIPLE ACCESS SYSTEM

(75) Inventors: Guodong Zhang, Farmingdale, NY (US); Jung-Lin Pan, Selden, NY (US); Yingming Tsai, Boonton, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/463,670

(22) Filed: Aug. 10, 2006

Related U.S. Application Data
(60) Provisional application No. 60/707,874, filed on Aug. 12, 2005.

(51) Int. Cl. H04J 11/00; H04Q 7/00

(52) U.S. Cl. 370/208; 370/329

(57) ABSTRACT

A method and apparatus for sending downlink control information in an orthogonal frequency division multiple access (OFDMA) system are disclosed. A Node-B allocates at least one subcarrier block to each of a plurality of wireless transmit/receive units (WTRUs) for transmission of downlink user data via an OFDMA downlink data channel in accordance with a scheduling mode. The Node-B compiles downlink control information based on the scheduling mode. The Node-B sends the downlink control information to the WTRUs via an OFDMA downlink control channel. The WTRUs receive and process the downlink user data based on the downlink control information.

### CROSS REFERENCE TO RELATED APPLICATION

This application claims the benefit of U.S. Provisional Application No. 60/707,874 filed Aug. 12, 2005, which is incorporated by reference as if fully set forth.

### FIELD OF INVENTION

The present invention is related to a wireless communication system. More particularly, the present invention is related to a method and apparatus for sending downlink control information in an orthogonal frequency division multiple access (OFDMA) system.

### BACKGROUND

The third generation partnership project (3GPP) and 3GPP2 are currently considering a long term evolution (LTE) of the universal mobile telecommunication system (UMTS) terrestrial radio access (UTRA). OFDMA is adopted for the downlink of the evolved UTRA.

In an OFDMA system, data is transmitted simultaneously over a plurality of orthogonal subcarriers. The subcarriers are divided into a plurality of subcarrier blocks. A localized subcarrier block is a basic resource unit in an OFDMA system. The localized subcarrier block includes a set of consecutive subcarriers. FIG. 1 illustrates two localized subcarrier blocks, each comprising four consecutive subcarriers.

One or more subcarriers blocks are assigned to wireless transmit/receive units (WTRUs) by a Node-B. In assigning the subcarrier blocks, the Node-B may implement frequency and time domain channel-dependent scheduling or frequency diversity-based scheduling.

FIG. 2 shows assignment of subcarrier blocks to multiple WTRUs according to frequency and time domain channel-dependent scheduling. Generally, a basic scheduling unit in frequency domain is one subcarrier block and a basic scheduling unit in time domain is one transmission time interval (TTI) or a period shorter than one TTI, (e.g., one OFDMA symbol duration within one TTI).

WTRUs with high data rate requirements may be assigned to several subcarrier blocks. For example, WTRU A, that has a high data rate requirement, is assigned to subcarrier blocks 1, 3 and 5 in TTI 1, and is assigned to subcarrier blocks 1 and 3-5 in TTI 2. Transmissions to WTRUs with low data rate requirements may be multiplexed into one subcarrier block in one TTI in a time division multiplexing (TDM) manner. For example, WTRUs B-E, that have a low data rate requirement, are assigned to subcarrier block 7 in TTI 2, and the transmissions to WTRUs B-E are multiplexed within TTI 2 in a TDM manner.

FIGS. 3A and 3B show assignment of subcarrier blocks to multiple WTRUs according to frequency diversity-based scheduling. The frequency diversity-based scheduling is applied when mobility is high or a received signal-to-interference plus noise ratio (SINR) is low. Multiple subcarrier blocks are assigned to a plurality of WTRUs, and transmissions to the WTRUs are multiplexed on the assigned subcarrier blocks. For example, in FIG. 3A, WTRUs A-F are assigned to subcarrier blocks 1, 3, 5 and 7 in TTI 1, and the transmissions to WTRUs A-F are multiplexed in all of the assigned subcarrier blocks. In an extreme case, all subcarrier blocks may be assigned to all WTRUs and transmissions to the WTRUs are multiplexed on all subcarrier blocks as shown in FIG. 3B.

In the prior art, the downlink control signaling only covers the case where localized subcarrier blocks are used, (i.e., frequency and time domain channel-dependent scheduling), and a WTRU uses all OFDM symbols of its assigned subcarrier blocks within a TTI.

In order for the WTRUs to receive and decode downlink transmissions, the Node-B sends downlink control information to the WTRUs via a downlink control channel. Therefore, it is desirable to provide an efficient method for sending the downlink control information to support operations in an OFDMA system.

### SUMMARY

The present invention is related to a method and apparatus for sending downlink control information in an OFDMA system. A Node-B allocates at least one subcarrier block to each of a plurality of WTRUs for transmission of downlink user data via an OFDMA downlink data channel in accordance with a scheduling mode. The Node-B compiles downlink control information based on the scheduling mode. The Node-B sends the downlink control information to the WTRUs via an OFDMA downlink control channel. The WTRUs receive and process the downlink user data based on the downlink control information.

### BRIEF DESCRIPTION OF THE DRAWINGS

FIG. 1 illustrates two localized subcarrier blocks, each comprising four consecutive subcarriers.

FIG. 2 shows assignment of subcarrier blocks to multiple WTRUs according to frequency and time domain channel dependent scheduling.

FIGS. 3A and 3B shows assignment of subcarrier blocks to multiple WTRUs according to frequency diversity scheduling.

FIG. 4 shows an OFDMA system configured in accordance with the present invention.

FIG. 5 is a block diagram of a Node-B configured in accordance with the present invention.

FIG. 6 shows an exemplary control packet format for frequency and time domain channel-dependent scheduling.

FIG. 7 shows an alternative control packet format for frequency and time domain channel-dependent scheduling.

FIG. 8 shows an exemplary control packet format for frequency diversity-based scheduling.

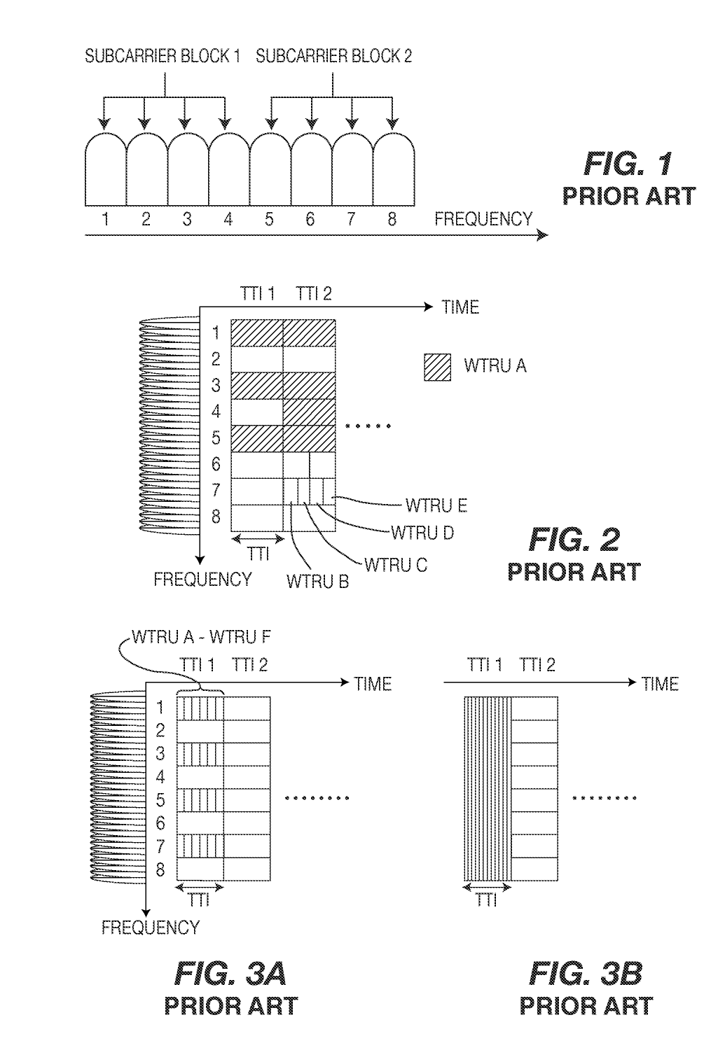

### DETAILED DESCRIPTION OF THE PREFERRED EMBODIMENTS

When referred to hereafter, the terminology “WTRU” includes but is not limited to a user equipment (UE), a mobile station, a fixed or mobile subscriber unit, a pager, or any other type of device capable of operating in a wireless environment. When referred to hereafter, the terminology “Node-B” includes but is not limited to a base station, a site controller, an access point or any other type of interfacing device in a wireless environment.

The features of the present invention may be incorporated into an integrated circuit (IC) or be configured in a circuit comprising a multitude of interconnecting components.

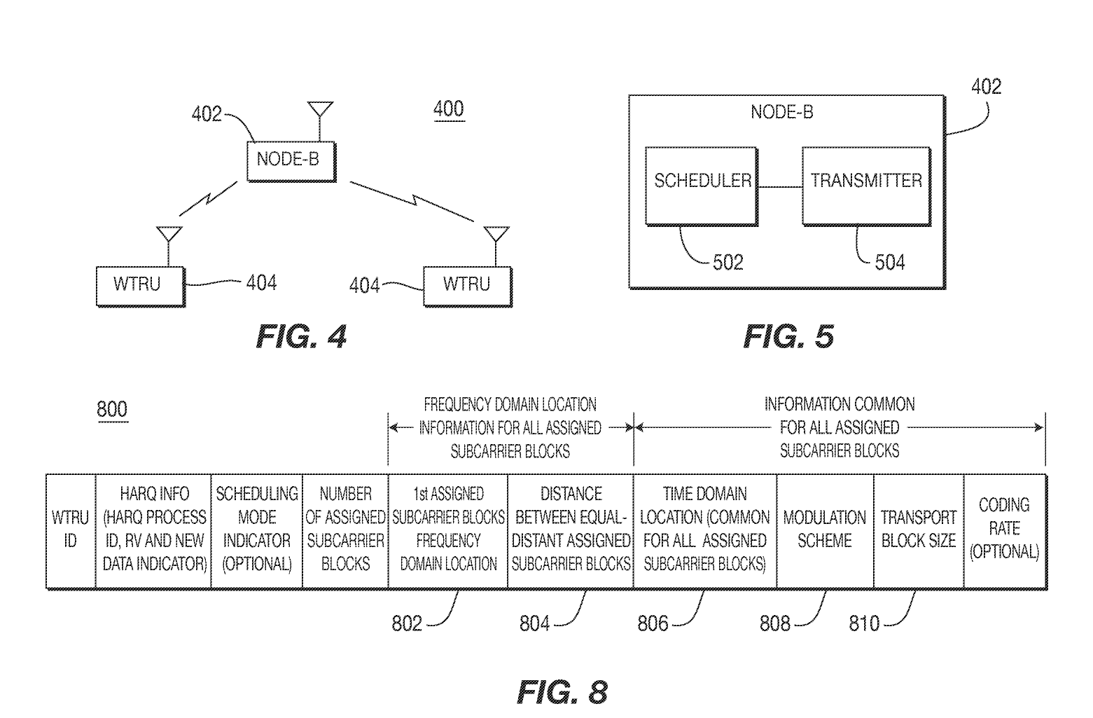

FIG. 4 shows an OFDMA system 400 configured in accordance with the present invention. The system 400 includes at least one Node-B 402 and a plurality of WTRUs 404. The Node-B 402 schedules downlink transmissions for the WTRUs 404 by implementing frequency and time domain channel-dependent scheduling or frequency diversity-based scheduling. The Node-B 402 sends downlink control information for OFDMA downlink data channel to the WTRUs 404 via a downlink control channel so that the WTRUs 404 may receive and decode OFDMA downlink transmissions from the Node-B 402 based on the downlink control information. The present invention provides an efficient method for transmitting the downlink control information, (physical layer and layer 2 information), for the downlink data channel in the OFDMA system 400.

FIG. 5 is a block diagram of a Node-B 402 configured in accordance with the present invention. The Node-B 402 includes a scheduler 502 and a transmitter 504. The scheduler 502 is configured to allocate at least one subcarrier block to each of a plurality of WTRUs 404 for transmission of downlink user data via an OFDMA downlink data channel. The transmitter 504 is configured to send the downlink control information to the WTRUs 404 via an OFDMA downlink control channel. The WTRUs 404 receive the downlink user data based on the downlink control information.

The control information includes at least one of scheduling information, demodulation information, hybrid automatic repeat request (H-ARQ) information and a scheduling mode indicator (optional). The scheduling information includes at least one of WTRU identity, a frequency domain location of assigned subcarrier block(s), and a time domain location of scheduled downlink transmissions to each WTRU. The demodulation information includes at least one of a data modulation scheme, a transport block size and a coding rate (optional). The H-ARQ information includes at least one of an H-ARQ process identity, a redundancy version (RV) and a new data indicator. The H-ARQ process identity indicated the H-ARQ process that the current transmission is addressing. The RV is to support incremental redundancy in soft combining. The new data indicator indicates that the current transmission is a new transmission so that a soft buffer is cleared.

When the Node-B implements frequency and time domain channel-dependent scheduling, the Node-B dynamically assigns at least one subcarrier block to each of the WTRUs at each TTI based on the channel condition. The frequency domain location of the assigned subcarrier block(s) is signaled to each of the WTRUs separately (or jointly).

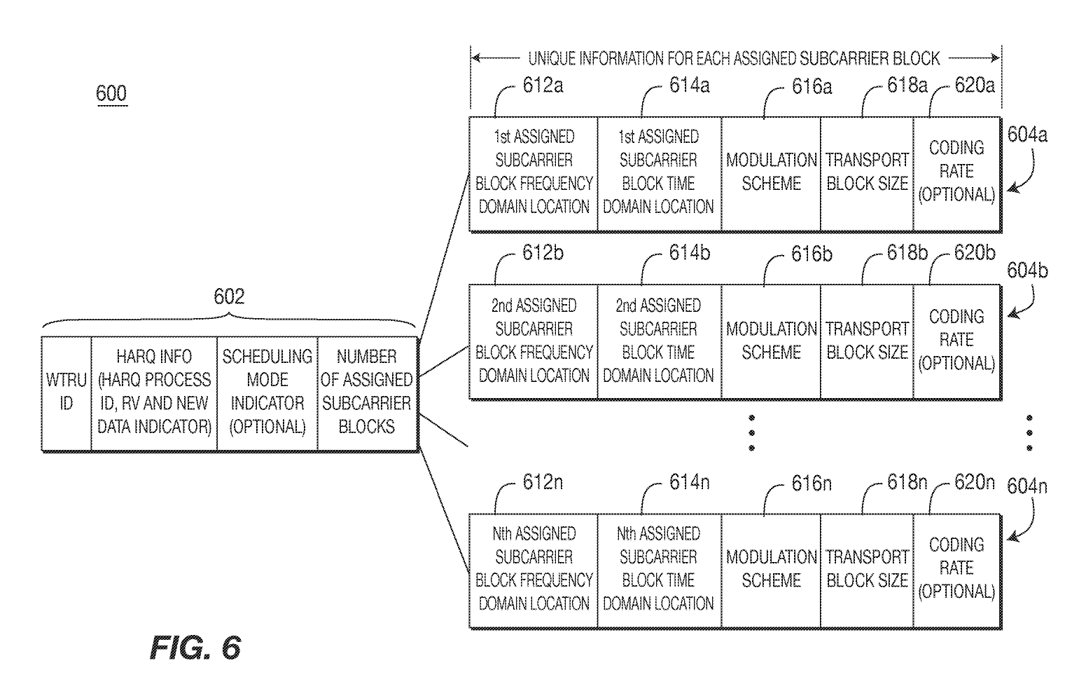

FIG. 6 shows an exemplary control packet 600 for frequency and time domain channel-dependent scheduling. The control packet 600 includes two parts, a first part 602 which is common to all assigned subcarrier blocks and one or more second parts 604a-604n. Each of the second parts 604a-604n is unique to each assigned subcarrier block. The first part 602 includes WTRU ID, H-ARQ information, a scheduling mode indicator (optional) and the number of assigned subcarrier blocks. Each second part 604a-604n includes, for each subcarrier block, an assigned subcarrier block frequency domain location 612a-612n, a time domain location 614a-614n, a modulation scheme 616a-616n, a transport block size 618a-618n and a coding rate 620a-620n (optional).

The Node-B may also perform time domain scheduling of downlink transmissions and sends the time schedule to the WTRUs via the time domain location 614a-614n in the control packet 600. The time domain scheduling is performed based on data rate requirements of WTRUs, (or buffer occupancy). For a WTRU with a low data rate requirement, (or low buffer occupancy), transmissions to such WTRUs may be multiplexed on a TTI basis or within a TTI as shown in FIG. 2. For a WTRU with a high data rate requirement, (or high buffer occupancy), transmissions to such WTRU are not multiplexed with transmissions to other WTRUs, but transmitted at all OFDMA symbol locations, (except the one used by control signaling and pilot signals), within the TTI.

When the transmissions to WTRUs are multiplexed within one TTI on one subcarrier block, (i.e., data to a particular WTRU is transmitted at one or several OFDMA symbols within the TTI), the symbol location for each WTRU for each assigned subcarrier is indicated by the time domain location field 614a-614n.

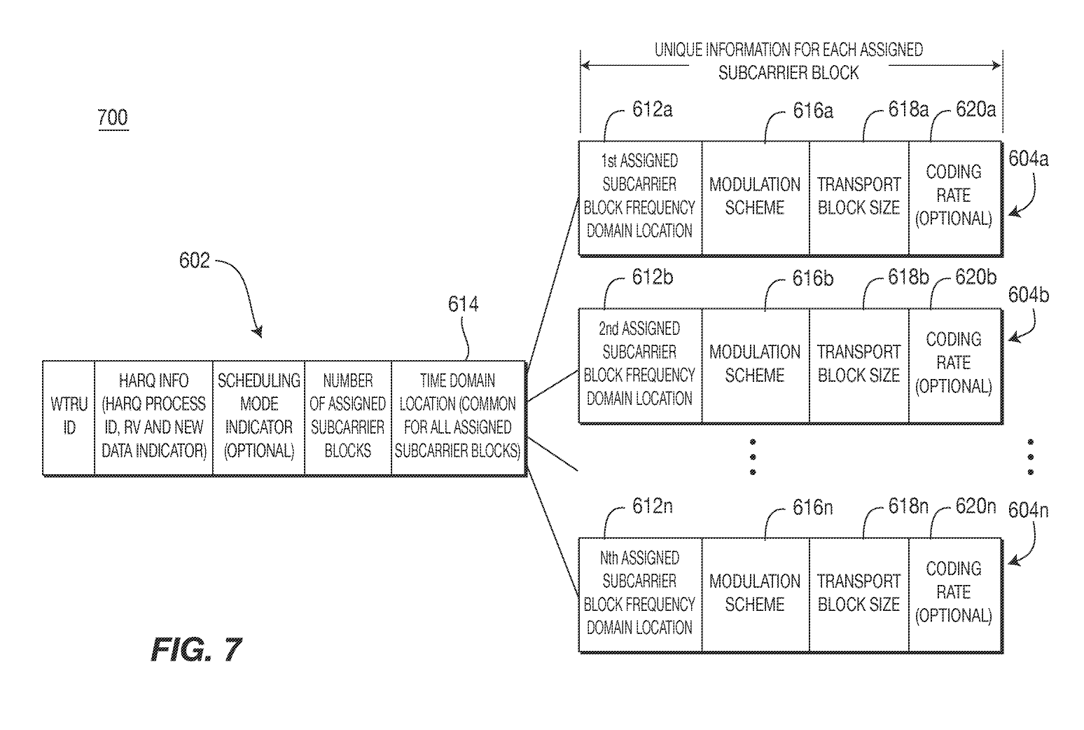

Alternatively, in order to reduce the amount of signaling, the Node-B may assign the same symbol location(s) within the TTI at each of its assigned subcarrier blocks. That is, the time domain location is the same for the WTRU in all its assigned subcarrier blocks. FIG. 7 shows an alternative control packet 700. Since the time domain location is the same in all of the assigned subcarrier blocks, the time domain location field 614 is included in the first part 602, which is common to all assigned subcarrier blocks and reduces a signaling overhead.

The Node-B may send a special indication to notify the WTRU that the transmissions to the WTRU are not multiplexed with transmissions to other WTRUs. Alternatively, such indication may be indicated implicitly by omitting the time domain location in the control packet. Alternatively, an invalid symbol location value may be used for such notification.

When the Node-B implements frequency and time domain channel-dependent scheduling, a data modulation scheme and transport block size information, (i.e., the number of information bits) for each subcarrier block are signaled separately in the modulation scheme field 616a-616n and the transport block size field 618a-618n in the second part 604a-604n of the control packet 600, as shown in FIGS. 6 and 7.

The coding rate may be derived from the data modulation scheme, the number of allocated subcarriers, and the transport block size. Therefore, the coding rate field 620a-620n may not be included in the control packet 600.

When the Node-B implements frequency diversity-based scheduling, multiple subcarrier blocks are assigned to multiple WTRUs and transmissions to the WTRUs are multiplexed on the assigned subcarrier blocks. In accordance with the present invention, the Node-B assigns multiple equally spaced subcarrier blocks to multiple WTRUs. Therefore, the Node-B needs to signal only the location of the first subcarrier block and the distance between two adjacent subcarrier blocks in frequency domain via the scheduling information.

FIG. 8 shows an exemplary control packet 800 for frequency diversity-based scheduling. The control packet 800 includes WTRU ID, H-ARQ information, a scheduling mode indicator (optional), the number of assigned subcarrier blocks, the first subcarrier block frequency domain location 802, the distance between two adjacent subcarrier blocks 804, a time domain location 806, a modulation scheme 808, a transport block size 810 and a coding rate (optional). Since the subcarrier blocks are equally spaced, it is necessary to signal only the first subcarrier block frequency domain location 802 and the distance between two adjacent subcarrier blocks 804, (which are for all assigned subcarrier blocks), instead of frequency domain locations of all assigned subcarrier blocks.

In accordance with the present invention, when the Node-B implements frequency diversity-based scheduling, one common time domain location, one common data modulation scheme and one common transport block size are assigned for all subcarrier blocks. Therefore, only one time domain location field 806, one modulation scheme field 808, one transport block size field 810 are necessary in the control packet 800 and the signaling overhead is much lower than that in the frequency and time domain channel-dependent scheduling.

It is not efficient to use the same control packet format for the frequency diversity-based scheduling and the frequency and time domain channel-dependent scheduling. Preferably, the scheduling mode is indicated by the scheduling mode indicator and a different control packet format is used for the frequency diversity-based scheduling and the frequency and time domain channel-dependent scheduling. Alternatively, the scheduling mode may not be explicitly indicated by the scheduling mode indicator, but may be indicated implicitly. Alternatively, the same control packet format may be used for both the frequency diversity-based scheduling and the frequency and time domain channel-dependent scheduling.

Alternatively, the same control packet format may be used for both frequency and time domain channel-dependent scheduling and frequency diversity-based scheduling. For example, the control packet 700 shown in FIG. 7 may be used for both frequency and time domain channel-dependent scheduling and frequency diversity-based scheduling. For frequency diversity-based scheduling, the same information is applied for each of the second part of the control frame. Simplicity is achieved at the cost of higher signaling overhead.

Although the features and elements of the present invention are described in the preferred embodiments in particular combinations, each feature or element can be used alone without the other features and elements of the preferred embodiments or in various combinations with or without other features and elements of the present invention.

What is claimed is:

1. In an orthogonal frequency division multiple access (OFDMA) system including a plurality of wireless transmit/receive units (WTRUs) and at least one Node-B, a method for sending downlink control information for downlink transmission, the method comprising:
a Node-B allocating at least one subcarrier block to each of the WTRUs for transmission of downlink user data via an OFDMA downlink data channel in accordance with a scheduling mode;
the Node-B compiling downlink control information based on the scheduling mode implemented by the Node-B; and
the Node-B sending the downlink control information to the WTRUs via an OFDMA downlink control channel, whereby the WTRUs receive and process the downlink user data based on the downlink control information.

2. The method of claim 1 wherein the downlink control information includes at least one of scheduling information, demodulation information, hybrid automatic repeat request (H-ARQ) information and a scheduling mode indicator

3. The method of claim 2 wherein the scheduling information includes at least one of WTRU identity, a frequency domain location of an assigned subcarrier block and a time domain location of downlink transmissions to the WTRUs.

4. The method of claim 3 wherein the scheduling mode is a channel-dependent scheduling mode and frequency domain locations of the assigned subcarrier blocks are signaled separately.

5. The method of claim 3 wherein downlink transmissions to WTRUs that have low data rate requirement are multiplexed in time domain.

6. The method of claim 5 wherein the downlink transmissions are multiplexed in one transmit time interval (TTI) and the time domain location indicates a symbol location within the TTI for each subcarrier block.

7. The method of claim 6 wherein a same symbol location is assigned on all subcarrier blocks assigned to each WTRU.

8. The method of claim 6 wherein downlink transmissions to WTRUs that have high data rate requirement are not multiplexed in time domain.

9. The method of claim 8 wherein the scheduling information indicates whether the downlink transmissions to the WTRUs are multiplexed or not.

10. The method of claim 9 wherein an omission of the symbol location indicates that the downlink transmissions are not multiplexed.

11. The method of claim 9 wherein an invalid symbol location is used to indicate that the downlink transmissions are not multiplexed.

12. The method of claim 3 wherein the scheduling mode is a frequency diversity-based mode and subcarrier blocks assigned to each of the WTRUs are spaced in equal distance in frequency domain.

13. The method of claim 12 wherein the frequency domain location indicates a location of a first subcarrier block and a distance between two adjacent subcarrier blocks in frequency domain.

14. The method of claim 2 wherein the demodulation information includes at least one of a modulation scheme, a transport block size, and a coding rate.

15. The method of claim 14 wherein the scheduling mode is a channel-dependent scheduling mode and the modulation scheme for each assigned subcarrier block is sent separately.

16. The method of claim 14 wherein the scheduling mode is a frequency diversity-based mode and a common modulation scheme is assigned for all subcarrier blocks assigned to each WTRU.

17. The method of claim 14 wherein the scheduling mode is a channel-dependent scheduling mode and the transport block size for each subcarrier block is sent separately.

18. The method of claim 14 wherein the scheduling mode is a frequency diversity-based mode and a common transport block size is assigned for all subcarrier blocks assigned to each WTRU.

19. The method of claim 1 wherein a different control packet format is used for sending the downlink control information depending on the scheduling mode.

20. The method of claim 1 wherein a same control packet format is used for sending the downlink control information regardless of the scheduling mode.

21. In an orthogonal frequency division multiple access (OFDMA) system including a plurality of wireless transmit/receive units (WTRUs) and at least one Node-B, a Node-B for sending downlink control information for downlink transmission, the Node-B comprising:
a scheduler configured to allocate at least one subcarrier block to each of the WTRUs for transmission of downlink user data via an OFDMA downlink data channel in accordance with a scheduling mode and compile downlink control information based on the scheduling mode; and
a transmitter configured to send the downlink control information to the WTRUs via an OFDMA downlink control channel, whereby the WTRUs receive and process the downlink user data based on the downlink control information.

22. The Node-B of claim 21 wherein the downlink control information includes at least one of scheduling information, demodulation information, hybrid automatic repeat request (H-ARQ) information and a scheduling mode indicator

23. The Node-B of claim 22 wherein the scheduling information includes at least one of WTRU identity, a frequency domain location of an assigned subcarrier block and a time domain location of downlink transmissions to the WTRUs.

24. The Node-B of claim 23 wherein the scheduling mode is a channel-dependent scheduling mode and frequency domain locations of the assigned subcarrier blocks are signaled separately.

25. The Node-B of claim 23 wherein downlink transmissions to WTRUs that have low data rate requirement are multiplexed in time domain.

26. The Node-B of claim 25 wherein the downlink transmissions are multiplexed in one transmit time interval (TTI) and the time domain location indicates a symbol location within the TTI for each subcarrier block.

27. The Node-B of claim 26 wherein a same symbol location is assigned on all subcarrier blocks assigned to each WTRU.

28. The Node-B of claim 26 wherein downlink transmissions to WTRUs that have high data rate requirement are not multiplexed in time domain.

29. The Node-B of claim 28 wherein the scheduling information indicates whether the downlink transmissions to the WTRUs are multiplexed or not.

30. The Node-B of claim 29 wherein an omission of the symbol location indicates that the downlink transmissions are not multiplexed.

31. The Node-B of claim 29 wherein an invalid symbol location is used to indicate that the downlink transmissions are not multiplexed.

32. The Node-B of claim 23 wherein the scheduling mode is a frequency diversity-based mode and subcarrier blocks assigned to each of the WTRUs are spaced in equal distance in frequency domain.

33. The Node-B of claim 32 wherein the frequency domain location indicates a location of a first subcarrier block and a distance between two adjacent subcarrier blocks in frequency domain.

34. The Node-B of claim 22 wherein the demodulation information includes at least one of a modulation scheme, a transport block size, and a coding rate.

35. The Node-B of claim 34 wherein the scheduling mode is a channel-dependent scheduling mode and the modulation scheme for each assigned subcarrier block is sent separately.

36. The Node-B of claim 34 wherein the scheduling mode is a frequency diversity-based mode and a common modulation scheme is assigned for all subcarrier blocks assigned to each WTRU.

37. The Node-B of claim 34 wherein the scheduling mode is a channel-dependent scheduling mode and the transport block size for each subcarrier block is sent separately.

38. The Node-B of claim 34 wherein the scheduling mode is a frequency diversity-based mode and a common transport block size is assigned for all subcarrier blocks assigned to each WTRU.

39. The Node-B of claim 21 wherein a different control packet format is used for sending the downlink control information depending on the scheduling mode.

40. The Node-B of claim 21 wherein a same control packet format is used for sending the downlink control information regardless of the scheduling mode.
